(19) United States
(12) Patent Application Publication
(10) Pub. No.: US 2010/0021671 A1
(43) Pub. Date: Jan. 28, 2010

(54) Twin adhesive tape

(76) Inventor: Jianbing Tu, Ninghai (CN)

Correspondence Address: Wilson wu, 19 Clipper Road, North York, Toronto, ON, M2J4C8, CA

(21) Appl. No.: 12/385,873

(22) Filed: Apr. 22, 2009

(30) Foreign Application Priority Data
Jul. 22, 2008 (CN) 200810040875.9

(51) Int. Cl. B32B 33/00

(52) U.S. Cl. 428/41.8; 428/42.1

(57) ABSTRACT

A twin adhesive tape has a release substrate, an adhesive layer adhesively and detachably attached to the release substrate. The adhesive layer has a lower adhesive layer, a printing substrate securely attached to the lower adhesive layer, a layer of plastic printing ink printed on the printing substrate, and an upper adhesive layer securely attached to the layer of plastic printing ink. The twin adhesive tape is thin yet strong enough, and able to use with a hand-held tape box.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a twin adhesive tape, and more particularly, to a twin adhesive tape which is thin, soft yet strong enough.

2. Description of Related Art

Chinese patent 01202243.8 “A Double-faced Tape” disclosed a kind of tape. As shown in FIG. 1, the tape 4 has a lower release paper 42, an upper release paper 42′, a core substrate 41, a lower adhesive layer 43 between a lower surface of the core substrate 41 and an upper surface of the lower release paper 42, an attachment layer 44 having an printed figure 40 and being attached to an upper surface of the core substrate 41 with a layer of adhesive 46, and an upper adhesive layer 45 between the attachment layer 44 and the upper release paper 42′. When the release papers 42 and 42′ are peeled off, the lower adhesive layer 42 is able to be attached to an adherent and a user is able to see the decorate figure 40. Another adherent may be applied to the upper adhesive layer 45.

According to the disclosure, the core substrate 41 may be of paper or plastic film such as polyethylene, polyvinyl chloride, rubber, or foam, and the attachment layer 44 may be of paper or plastic film.

This double-faced tape has a drawback that it is thick since the existence of the core substrate 41 and the attachment layer 44. For a same length of useful tape, a packaged volume and weight become large. And when attaches a pile of such as papers, a portion which the tapes sandwiched between papers looks much thicker than other part. It negatively affects appearance of the pile.

### BRIEF SUMMARY OF THE INVENTION

The main object of the invention is to provide a twin adhesive tape which is thin yet strong enough.

Another object of the invention is to provide a twin adhesive tape which is so thin yet strong enough to use with a hand-held tape box.

In order to accomplish the above objects, the present invention provides a twin adhesive tape having a release substrate and an adhesive layer adhesively and detachably attached to the release substrate. The adhesive layer has a lower adhesive layer, a printing substrate securely attached to the lower adhesive layer, a layer of plastic printing ink printed on the printing substrate, and an upper adhesive layer securely attached to the layer of plastic printing ink.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is an exploded perspective view of a conventional double-faced tape.

FIG. 2 is a cross-sectional view of the preferred embodiment of the twin adhesive tape of the invention with an upper substrate is removed.

FIG. 3 is a partial and cross-sectional view of the preferred embodiment shown in FIG. 2.

FIG. 4 is a cross-sectional view of another embodiment of the twin adhesive tape of the invention.

FIG. 5 is a schematic perspective view showing when the twin adhesive tape of the invention is used with a hand-held tape box.

FIG. 6 is a flat exploded view showing the twin adhesive tape and the hand-held tape box used therewith as shown in FIG. 5. And,

FIG. 7 is a cross-sectional view of the twin adhesive tape shown in FIGS. 5 and 6.

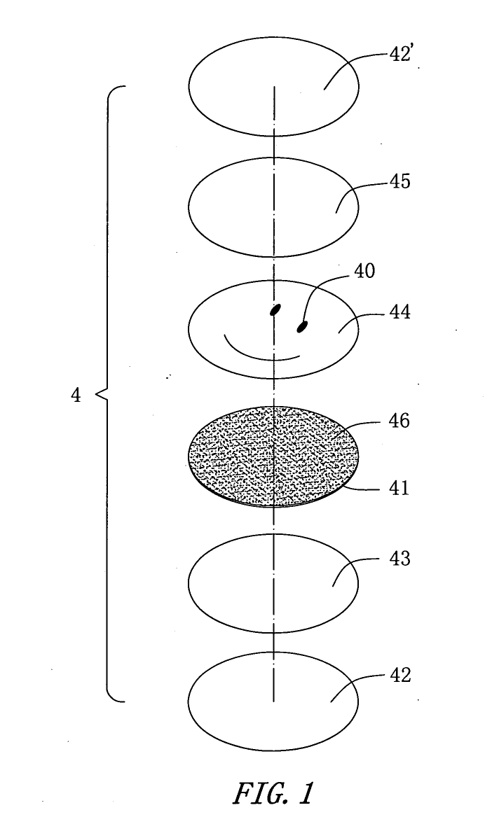

### DETAILED DESCRIPTION OF THE INVENTION

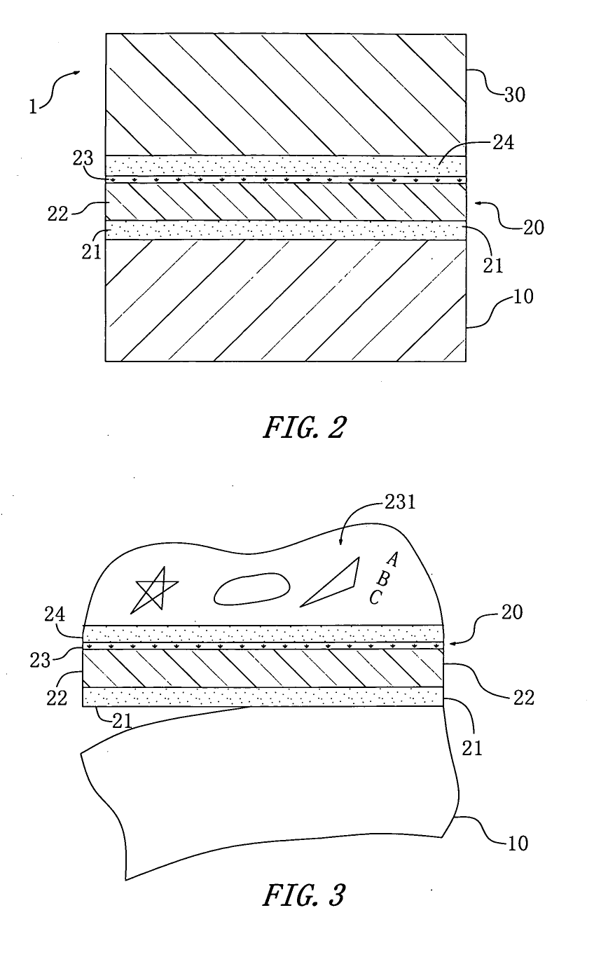

With reference to FIGS. 2 and 3, the preferred embodiment of a twin adhesive tape 1 of the invention is shown. The twin adhesive tape 1 has a release substrate 10 which is made of paper or plastic film, and an adhesive layer 20 adhesively and detachably attached thereto. The adhesive layer 20 has a lower adhesive layer 21, a printing substrate 22 securely attached to the lower adhesive layer 21, a layer of plastic printing ink 23 printed on the printing substrate 22, and an upper adhesive layer 24 securely attached to the layer of plastic printing ink 23. In this preferred embodiment, the adhesive layer 20 attaches to the release substrate 10 with the lower adhesive layer 21 thereof. A release cover 30, which is made of paper or plastic film, is attached to the upper adhesive layer 24 of the adhesive layer 20.

As particularly shown in FIG. 3, when the release cover 30 is removed from the adhesive layer 20, a user will be able to see a figure 231 printed on the printing substrate 22. The figure 231 can be for decoration or advertisement. A thickness of the printing substrate 22 may be between 0.005 and 0.02 millimeter. The printing substrate 22 is able to be made of such material that contains 17 to 23 water, 18 to 22 acrylic emulsion, 1.8 to 2.2 glycol, 0.18 to 0.22 ammonia, and 27 to 33 thickening agent which contains 17 to 23 water, 0.04 to 0.08 ammonia, and 1.2 to 1.6 natrosol (Unit: Kilogram/Portion).

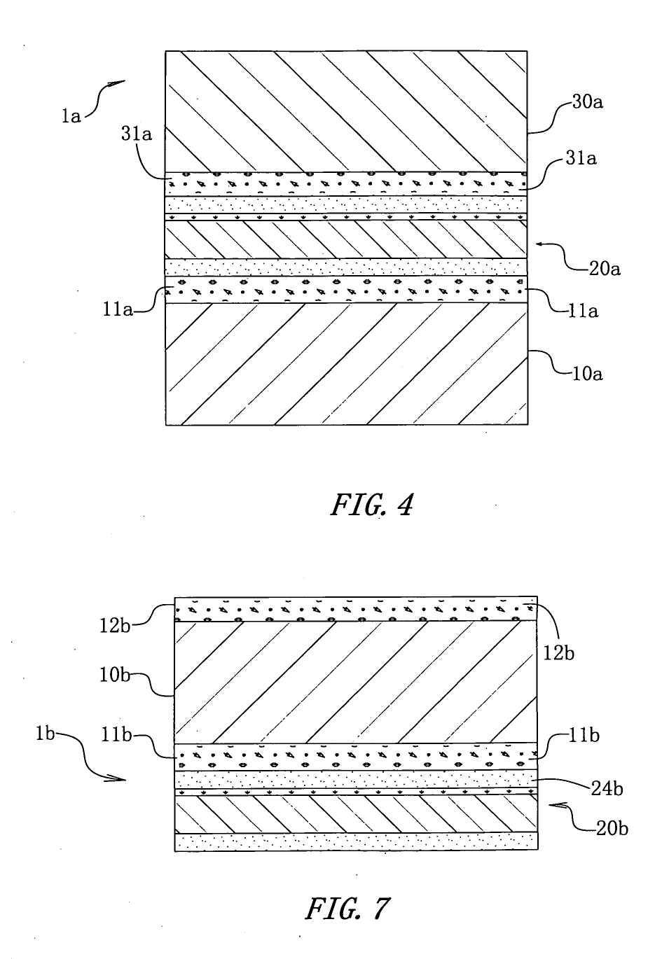

With reference to FIG. 4, a cross-sectional view of another embodiment of the twin adhesive tape 1a of the invention is shown. In this embodiment, an anti-adhesion coating layer 11a is provided on a surface of the release substrate 10a attaching the adhesive layer 20a. And a cover anti-adhesion coating layer 31a is provided on a surface of the release cover 30a attaching the adhesive layer 20a. The anti-adhesion coating layers 11a and 31a are able to be made of silicon oil diluted with number 120 gasoline.

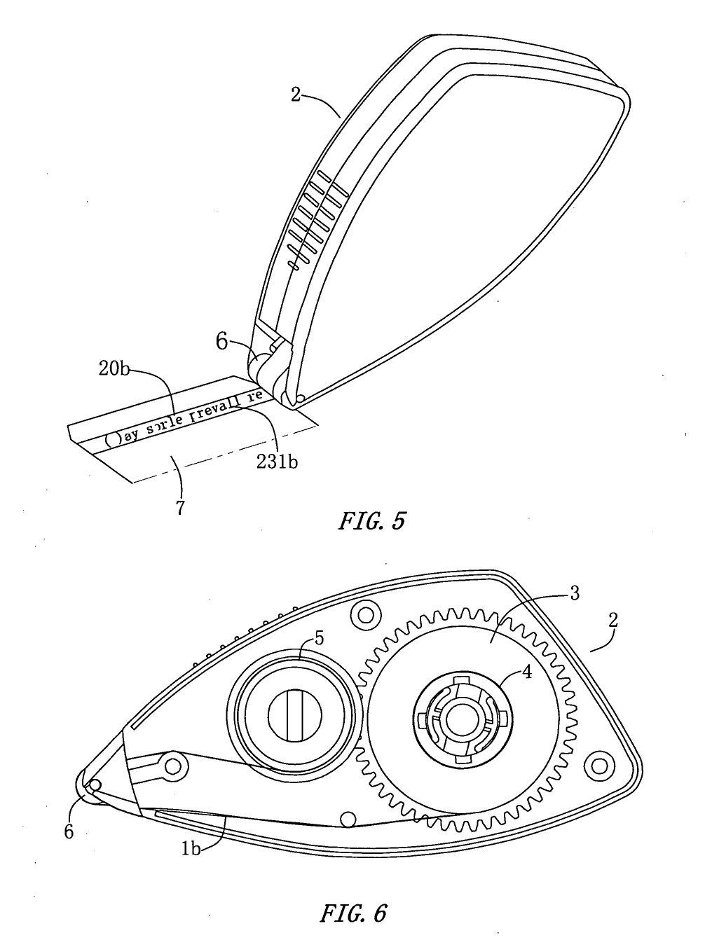

With reference to FIGS. 5, 6 and 7, another embodiment of the twin adhesive tape 1b of the invention is shown. An adhesive layer 20b attaches to the release substrate 10b with an upper adhesive layer 24b thereof and an anti-adhesion coating layer 11b, 12b is provided on each surface of the release substrate 10b. The twin adhesive tape 1b is a narrow and long tape, wound into a coil 3, and used with a hand-held tape box 2. The coil 3 is able to be installed on a loading spool 4. A free end of the coil 3, passing over a head roller 6, is attached on a receiving spool 5.

In use, a user is able to place the twin adhesive tape 1b on an adherent 7 and then move the tape box 2 with exerting a certain pressure on the twin adhesive tape 1b. The twin adhesive tape 1b goes from the loading spool 4 to the receiving spool 5 as the tape box 2 moves, leaving the adhesive layer 20b on the adherent. And the figure 231b of the adhesive layer 20b is able to be seen.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A twin adhesive tape comprising:
a release substrate; and,
an adhesive layer adhesively and detachably attached to said release substrate; said adhesive layer having a lower adhesive layer, a printing substrate securely attached to said lower adhesive layer, a layer of plastic printing ink printed on said printing substrate, and an upper adhesive layer securely attached to said layer of plastic printing ink.

2. The twin adhesive tape as claimed in claim 1, wherein said adhesive layer attaches to said release substrate with said lower adhesive layer thereof and a release cover is attached to said upper adhesive layer of said adhesive layer.

3. The twin adhesive tape as claimed in claim 2, wherein an anti-adhesion coating layer and a cover anti-adhesion coating layer are respectively provided on a surface of said release substrate attaching said adhesive layer and on a surface of said release cover attaching said adhesive layer.

4. The twin adhesive tape as claimed in claim 1, wherein said adhesive layer attaches to said release substrate with said upper adhesive layer thereof and an anti-adhesion coating layer is provided on each surface of said release substrate; said twin adhesive tape is a narrow and long tape being wound into a coil, and used with a hand-held tape box.

5. The twin adhesive tape as claimed in claim 1, wherein a thickness of said printing substrate is between 0.005 and 0.02 millimeter.

6. The twin adhesive tape as claimed in claim 1, wherein said printing substrate is made with such material that contains 17 to 23 water, 18 to 22 acrylic emulsion, 1.8 to 2.2 glycol, 0.18 to 0.22 ammonia, and 27 to 33 thickening agent which contains 17 to 23 water, 0.04 to 0.08 ammonia, and 1.2 to 1.6 natrosol (Unit: Kilogram/Portion).

7. The twin adhesive tape as claimed in claim 2, wherein a thickness of said printing substrate is between 0.005 and 0.02 millimeter.

8. The twin adhesive tape as claimed in claim 3, wherein a thickness of said printing substrate is between 0.005 and 0.02 millimeter.

9. The twin adhesive tape as claimed in claim 4, wherein a thickness of said printing substrate is between 0.005 and 0.02 millimeter.

10. The twin adhesive tape as claimed in claim 2, wherein said printing substrate is made with such material that contains 17 to 23 water, 18 to 22 acrylic emulsion, 1.8 to 2.2 glycol, 0.18 to 0.22 ammonia, and 27 to 33 thickening agent which contains 17 to 23 water, 0.04 to 0.08 ammonia, and 1.2 to 1.6 natrosol (Unit: Kilogram/Portion).

11. The twin adhesive tape as claimed in claim 3, wherein said printing substrate is made with such material that contains 17 to 23 water, 18 to 22 acrylic emulsion, 1.8 to 2.2 glycol, 0.18 to 0.22 ammonia, and 27 to 33 thickening agent which contains 17 to 23 water, 0.04 to 0.08 ammonia, and 1.2 to 1.6 natrosol (Unit: Kilogram/Portion).

12. The twin adhesive tape as claimed in claim 4, wherein said printing substrate is made with such material that contains 17 to 23 water, 18 to 22 acrylic emulsion, 1.8 to 2.2 glycol, 0.18 to 0.22 ammonia, and 27 to 33 thickening agent which contains 17 to 23 water, 0.04 to 0.08 ammonia, and 1.2 to 1.6 natrosol (Unit: Kilogram/Portion).
